(19) United States
(12) Patent Application Publication
(10) Pub. No.: US 2004/0056022 A1
(43) Pub. Date: Mar. 25, 2004

(54) Method and device for the selective laser sintering of metallic substances

(76) Inventors: Wilhelm Meiners, Aachen (DE); Konrad Wissenbach, Herzogenrath (DE); Christoph Over, Aachen (DE)

Correspondence Address: VENABLE, BAETJER, HOWARD AND CIVILETTI, LLP, P.O. BOX 34385, WASHINGTON, DC, 20043-9998, US

(21) Appl. No.: 10/467,014

(22) PCT Filed: Jan. 10, 2002
(86) PCT No.: PCT/DE02/00049

(30) Foreign Application Priority Data
Feb. 2, 2001 (DE) 101 04 732.0

(51) Int. Cl. B05D 3/00; H05B 6/10

(52) U.S. Cl. 219/634; 427/555

(57) ABSTRACT

The present invention relates to a device and a method for the selective laser sintering of metallic substances. The construction volume of the device is delimited by side walls (2) and by a construction platform (3), which is adjustable in height, for building up a component (9). A heating plate (5) is placed on the construction platform (3) at a distance from the side walls (2) or is integrated in the surface of the construction platform (3). The heating plate (5) is designed and thermally insulated from the construction platform (3) by an insulation layer (4) in such a manner that it reaches temperatures of at least 500° C. during heating operation. With the device and the corresponding method, metallic components are maintained at temperatures above 500° C. during the building up process thereby reducing the danger of tensions or cracking in the component.

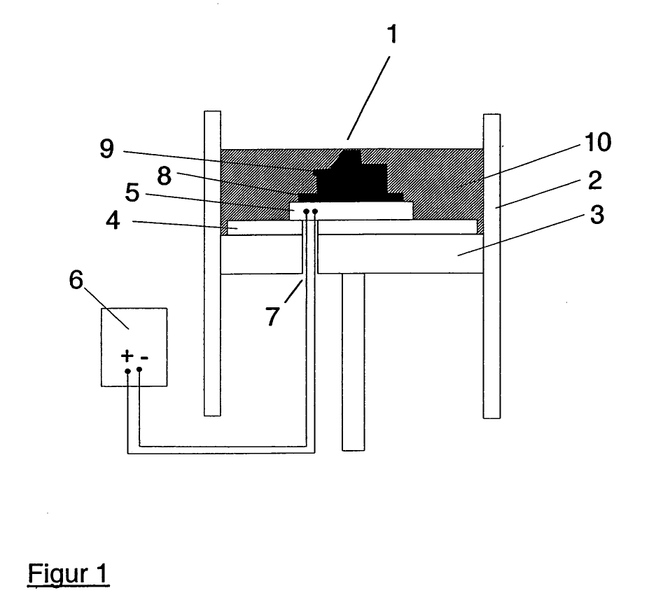

### TECHNICAL FIELD OF APPLICATION

The present invention relates to a device and a method for selective laser sintering of metallic substances in a process chamber with a construction volume delimited by side walls and by a platform, which is adjustable in height, for building up a component. The component is built up in layers on a substrate plate, which lies on the construction platform at a distance from the lateral walls, by repeated application of a layer of powdered substance and sintering the layer with a laser beam.

The present invention and the corresponding method can be used in product development for so-called rapid prototyping to shorten product development times and to improve product quality. This is made possible because a rapid prototyping method such as the selective laser sintering of the present invention permits very fast production of prototype components directly from a 3D-CAD model and follow-up evaluation, obviating the time-consuming installation of a NC program for milling, eroding or producing shaping tools.

The aim of developing new, respectively further developing existing, rapid prototyping methods is to be able to process substances that approximate those employed in series production as closely as possible or that even are identical to those employed in series production. This also applies, in particular, to metallic prototypes or tool prototypes. The present method of selective laser sintering permits producing components made of commercially available steels, thus high-melting metals, respectively high-melting metal alloys, or other metallic substances. The components are applied in layers on a construction platform, respectively a substrate plate placed thereupon. For this purpose, the substance is repeatedly applied in powder form as a thin layer on the substrate plate and locally sintered in each layer plane corresponding to the to-be-generated geometry of the component using a laser beam. Metal components, for example of stainless steel 1.4404, titanium or aluminum, produced with this method meet the prescribed substance specifications regarding density and solidity. Thus they can be utilized as function prototypes or directly as a sturdy component.

### STATE OF THE ART

Devices and methods for rapid prototyping, in which the prototype components are produced from low-melting plastics using the selective laser sintering method are known from A. Gebhardt's, Rapid Prototyping, Carl Hanser Verlag Munchen, Vienna, pp. 115/116. The plastic powder used is composed of slightly predensified grains, which are slightly sintered locally layer by layer and fuse to form a hard layer after solidification. In order to reduce the amount of energy the laser beam has to introduce to sinter slightly, in this method the process chamber is heated to just below the melting point of the plastic powder. In this way, the entire construction area, i.e. the construction platform, the side walls, the component, the applied powder and the powder surrounding the component, and the atmosphere in the process chamber are uniformly heated to a temperature just below the melting point of the plastic powder, i.e. below 200° C., thereby reducing considerably the amount of energy the laser has to introduce in order to slightly sinter the powder. In such a type method, preheating the process chamber volume usually occurs from above by means of an infrared radiator or by introducing a hot gas into the process chamber.

However, such a method of reducing the energy density of the laser beam cannot be realized when producing components composed of high-melting metallic substances due to their very high melting temperatures.

Another method and corresponding device for rapid prototyping by means of selective sintering is known from WO 96/29192 A1. In the apparatus of this printed publication, the laterally delimiting walls of the construction volume and the floor plate required for holding the powder bed are built up directly of the powdered substance during the building up process so that after a component is finished, the entire complex of floor, side walls and the finished component in the supporting powder is removed from the apparatus. In order to shorten the building up time, a manner of building up is proposed in which a heating spiral is integrated in the construction platform. This heating spiral generates a temperature between 80° C. and 160° C. for a certain period of time at the beginning of the building up process in order to solidify the floor layer by means of this auxiliary heating means and not by means of the laser. Solidification of the layer is achieved at these temperatures, because the substances used are plastics or very low-melting alloys with melting points distinctly below 200° C.

A method and apparatus for selective laser sintering high-melting metallic powdered substances is known from DE 196 49 865 C1. This apparatus comprises a construction volume in a process chamber. The construction volume is provided under a floor area of the process chamber and is delimited by side walls and by a construction platform, which is adjustable in height, for building up of a component. Furthermore, a leveling unit is provided in the process chamber for spreading the powdered substance as a layer of constant thickness over a section of the floor area. Local sintering of each layer according to a desired geometry of the component occurs using a laser optic with a corresponding scanning unit. Components made of high-melting metals, such as for example commercially available steels, whose substance properties correspond to or at least closely approximate those of a component produced in the conventional manner, can be produced with this apparatus.

However, especially in fabricating such type components of high-melting metals, respectively of high-melting metal alloys, there arises the problem of high tensions occurring in the component during processing, which can lead to cracking during production.

The object of the present invention is to provide a device and a method for selective laser sintering high-melting metallic substances which permits the production of a component with reduced tension buildup.

### DESCRIPTION OF THE INVENTION

The object is solved using the device and the method according to the patent claims 1 and 9. Advantageous embodiments of the device are the subject matter of the subclaims.

The device is composed in the state-of-the-art manner of a process chamber with a construction volume, which is provided under a floor area of the process chamber and which is delimited by side walls and by a construction platform, which is adjustable in height, for building up the component. Furthermore, the device is provided with a leveling unit for spreading the powdered substance as a layer of constant thickness over a section of the floor area as well as a laser optic and a scanning unit for scanning a section of the floor area with a laser beam. This device is distinguished by a heating plate being placed on the floor platform at a distance from the side walls or being integrated in the surface of the floor platform. The heating plate is designed and thermally insulated from the construction platform by an insulation layer in such a manner that it reaches temperatures above 500° C. during heating operation. The heating plate serves either directly as the substrate plate for building up the component or as a support for this substrate plate. Such a type metallic substrate plate is required for selective laser sintering to be able to build up corresponding components on it and to remove them from the construction volume. Furthermore, the purpose of the substrate plate is to affix the component on the construction platform during the building up process.

The inventors of the present device, respectively of the present method, have understood that heating the component to temperatures of at least 500° C. during selective sintering of high-melting metallic powdered substances can lead to reducing tensions in the component considerably during the building up process. Surprisingly, it was discovered that such heating in a device for selective laser sintering can be realized by heating the finished parts of the component directly thereby obviating complicated design of the outer walls of the process chamber and averting problems due to thermal delay of the component provided in the process chamber.

A precondition for the problemless realization of these temperatures in the component is designing the device according to the present claim 1. This embodiment requires, in addition to designing the heating plate for generating such high temperatures at its surface, placing it at a distance from the side walls and insulating it sufficiently from the construction platform. The good thermal conductivity of the layers of metallic substances sintered using the method of selective laser sintering also raises the temperature of the component, respectively of the finished part of the component, located on the substrate, respectively on the heating plate, to the set temperature. Thermal insulation is only required between the substrate plate, respectively the heating plate, and the construction platform. Insulation between the hot component and the side walls of the construction chamber is assumed by the surrounding powder, because the thermal conductivity of spread powder is very low. With this embodiment of the present invention, the high temperature is, therefore, limited solely to the sintered areas of the component and the adjacent powdered substance.

In one embodiment, the substrate is designed directly as the heating plate, for example by direct integration of the heating wires in this substrate plate. Furthermore, the substrate plate can be placed on a special heating plate or heated directly by induction.

In this embodiment, the heating plate, respectively the substrate plate, should have a low thermal expansion coefficient, preferably below 15*10⁻⁶ K⁻¹.

In another embodiment, means are provided for affixing the heating plate laterally on the construction platform.

In the preferred embodiment of the present device, a temperature sensor is placed in the heating plate or in the substrate plate. The temperature sensor is connected to a control for the energy supply of the heating plate to maintain the temperature of the heating plate, respectively the temperature of the substrate plate, constant during the building up process of the component. Heating, of course, occurs during the entire construction process.

### WAYS TO CARRY OUT THE INVENTION

The device will be described briefly once more in the following using a preferred embodiment with reference to the accompanying drawing.

The figure shows schematically an exemplary detail of an invented device. The detail shows that the construction volume 1 is laterally delimited by the side walls 2 and downward by the construction platform 3, which is adjustable in height. The height adjustment of construction platform 3 is realized by means of a drive which is not shown in the drawing. On the construction platform 3 lies an insulation plate 4, which thermally insulates the heating plate 5 lying on the insulation plate 4 from the construction platform 3. The energy supply 6 for the heating plate 5 is connected to the heating plate 5 via corresponding passages 7 in the construction platform 3.

In the present example, a separate substrate plate 8 is used, which lies directly on the heating plate 5. The substrate plate 8 is composed of the same or of a similar substance as the to-be-produced component 9. In the figure, the component 9 is already finished and is embedded in the surrounding powdered substance 10.

The construction of this component 9 occurs in the state-of-the-art manner in that first the construction platform 3 is pushed with the substrate plate 8 up to just below the floor area of the process chamber, which is at the level of the top ends of the side walls 2. Then a layer of powder is applied to the construction platform with the substrate plate and sintered with a laser beam corresponding to the desired geometry of the component. The construction platform is then lowered by a defined layer thickness and the procedure begins anew. In the present method, the heating plate 5 is operated at a temperature of 500° C. or above during the entire process so that component 9, respectively the finished areas thereof, always have approximately this temperature. Due to this high temperature of the component, which usually lies distinctly below the melting point of the component, tensions in the components are reduced during the building up process thereby preventing the risk of cracking or tensions remaining in the component.

Of course, the correspondingly designed heating plate can also be used for thermal follow-up treatment of the finished components after their completion.

What is claimed is:

1. A device for selective laser sintering of metallic substances which is provided with a construction volume in a process chamber, said construction volume being provided below a floor area of said process chamber and being delimited for building up a component (9) by side walls (2) and a construction platform (3), which is adjustable in height, and said device is provided with a leveling unit for spreading a powdered substance as a layer of constant thickness over a section of the floor area as well as with a laser optic and a scanning unit for scanning a region of the floor area with a laser beam, wherein
a heating plate (5) is placed on said construction platform (3) at a distance from said side walls (2) or is integrated in the surface of said construction platform (3), with said heating plate (5) being designed in such a manner and being thermally insulated by a insulation layer (4) from said construction platform (3) that it reaches temperatures of ≧500° C. during heating operation.

2. A device according to claim 1, wherein
said heating plate (5) is designed as a substrate plate (8), on which said component (9) is built up.

3. A device according to claim 1 or 2, wherein
said heating plate (5) is provided with integrated heating wires.

4. A device according to claim 1 or 2, wherein
an induction device is provided for inductive heating of said heating plate (5).

5. A device according to one of the claims 1 to 4, wherein
said heating plate (5) is made of a substance with a thermal expansion coefficient of ≦15*10⁻⁶ K⁻¹.

6. A device according to one of the claims 1 to 5, wherein
said heating plate (5) lies on an insulation plate (4) as an insulation layer, which extends laterally beyond said heating plate (5).

7. A device according to one of the claims 1 to 6, wherein
a control means is provided in connection with a temperature sensor disposed in said heating plate (5) or in said substrate plate (8), said control means maintaining said heating plate (5) respectively said substrate plate (8) at a constant temperature.

8. A device according to one of the claims 1 to 7, wherein
means are provided for affixing of said heating plate (5) laterally on said construction platform (3).

9. A method for selective laser sintering of metallic substances in a process chamber having a construction volume, which is delimited by side walls (2) and by a construction platform (3), which is adjustable in height, for building up a component (9), with said component (9) being built up by means of repeated application of a layer of a powdered substance and sintering, using a laser beam, said layer onto a substrate plate (8), which lies on said construction platform (3) at a distance from said side walls (2), wherein
said substrate plate (8) is thermally insulated from said construction platform (3) and is heated to temperatures of ≧500° C. during the building up process.
